(19) United States
(12) Patent Application Publication
(10) Pub. No.: US 2010/0198716 A1
(43) Pub. Date: Aug. 5, 2010

(54) System and Method of Coordinating the Trading of Securities and Instruments with Disparate Communication Modalities

(75) Inventors: Peter Chatzky, Briarcliff Manor, NY (US); Jefrey Schell, Ossining, NY (US); Farman Ulhaq, New York, NY (US)

Correspondence Address: PRYOR CASHMAN, LLP, 7 Times Square, NEW YORK, NY, 10036-6569, US

(73) Assignee: NAPA GROUP, LLC, New York, NY (US)

(21) Appl. No.: 12/699,516

(22) Filed: Feb. 3, 2010

Related U.S. Application Data
(60) Provisional application No. 61/149,404, filed on Feb. 3, 2009.

(51) Int. Cl. G06Q 40/00; G06F 17/30; G06F 15/16

(52) U.S. Cl. 705/37; 707/802; 709/206; 707/E17.044

(57) ABSTRACT

A method and system of networking various users trading securities such as short-term adjustable rate securities, longer term fixed income securities, and other instruments. A plurality of instances of trading software residing on one or more computers accessible by a plurality of users are connected to a centralized hub having at least one database. On the database are stored a plurality of user profiles, each of the profiles including at least messaging preferences of the respective users. Trading messages may be sent in a first format from a first sending user to the centralized hub. At the hub, at least one second recipient user of the trading message is determined. The sent message is then transmitted from the hub to the at least one second recipient user in accordance with the at least one second recipient user's user profile stored on the hub.

### RELATED APPLICATIONS

Domestic priority is claimed from U.S. Provisional Patent Application No. 61/149,404 entitled “System and Method of Coordinating the Trading of Non-Standard Securities and Instruments with Disparate Communication Modalities”, filed Feb. 3, 2009, the entirety of which is incorporated by reference herein.

### BACKGROUND OF THE INVENTION

1. Field of the Invention

The invention relates to electronic systems for trading securities, more specifically short-term adjustable rate securities, including those with non-standard variables and parameters, such as auction rate securities.

2. Description of Related Art

Conventional exchanges such as the New York Stock Exchange and NASDAQ effect the trading of conventional securities, stocks, mutual funds, and the like. However, many other financial instruments for which there is no present formal electronic marketplace would also benefit from a streamlined electronic platform. Such instruments, which include but are not limited to Variable Rate Demand Notes (VRDN's or VRDO's), auction rate securities, and commercial paper, would benefit from facile interaction among interested parties, such as syndicators of an initial offering, buyers and sellers in the secondary marketplace, and clearing agents or custodians. In addition, investors, regulators, or issuers would benefit from a well-defined architecture that provided a clearinghouse for accurate, timely data transmission.

Auction rate securities are an example of one type of security that would benefit from an electronic platform designed to simplify trade data dissemination and thereby foster liquidity. Typically, auction rate securities are debt instruments issued by a municipality or agency, in which the yield paid to investors is reset periodically via a Dutch auction. In a Dutch auction, all successful bidders receive the lowest yield that results in the sale of the entire amount of a security offered for sale. Multiple parties are involved with the auction process, including issuers, broker/dealers, investors, and auction agents, all of whom need timely, accurate information related to the securities in the marketplace, the schedule of auctions, the auction data to be considered, and the results of the automated auction process.

Because auction rate securities are often distributed via a limited syndicate of broker/dealers who hold “bidding rights” to participate in the regular auctions, holders wishing to unload positions between auction dates face a daunting task of finding potential buyers. A selling investor must rely on the energy and enthusiasm of his broker/dealer to find a willing buyer, compute accumulated interest, generate a marketable security price, and potentially transfer bidding rights to another firm.

An active electronic marketplace that handles the specific attributes of this security class would alleviate these problems.

Today's conventional approaches fail to solve these problems. One current well-marketed solution merely provides a website on which potential purchasers and sellers generically lists securities investors may be selling or seeking. Once a party sees another potential party with whom it wishes to transact, communication occurs manually via e-mail or telephone. There is no bilateral communication enabled through this process, which is effectively no more complex or helpful than traditional classified advertisements.

Several market offerings require vital trade data that must be accumulated manually, offering no practical way to scale the solution to meet the needs of a large (or growing) marketplace.

Inadequate systems currently offered in the marketplace often fail to account for the intricacies of the specific type of security being traded. Using auction rate securities again as an example, an instrument class may trade with “bidding rights,” meaning that only specifically authorized broker/dealers may participate in regularly scheduled auctions that set the interest rate paid. The inventors are not aware of any systems that are capable of tracking the bidding rights among designated and non-designated broker/dealers and their customers.

Furthermore, other security types have specific regulatory reporting requirements, or investor requirements that are not adequately handled by current marketplace systems. The interest rate paid by a variable rate instrument, such as VRDN's and VRDO's, may reset on a daily basis. Automating the feed of such rate changes to Municipal Market Data (MMD) owned by Thomson Reuters, or to investors, or issuers, is a fundamental part of the process that should be address by the trading platform. As a second example, investors and issuers of Commercial Paper typically require notification of “price tranches” identifying interest rates for various maturities of a trade.

Thus, there is a clear need for adequate and timely dissemination of vital security and trade information, and a system to handle the specific trading characteristics and security class attributes across a range of product types. Such a system would need to provide automated, electronic delivery to multiple participants, including issuers, broker/dealers, investors, regulators, and potentially other interested parties.

### SUMMARY OF THE INVENTION

The invention is an integrated system of data dissemination, coordinating the trading of securities and instruments among multiple parties using disparate communication modalities. In one embodiment, the invention is an open network that facilitates and enables secondary market trading of fixed income securities, in particular short-term instruments such as auction rate securities, variable rate demand notes, and commercial paper. The network is designed to allow any number of market participants to buy and sell posted offerings, at a negotiated price, while providing account management, transparency into the details of the security, research capabilities, and offering statements to investors, trustees, issuers and obligors.

A second purpose of the invention is to disseminate market data, including but not limited to security characteristics, investor positions, interest rates, or fees, among a diverse group of market participants.

A centralized message processing facility permits various applications to communicate via well-defined message types and formats, using industry-standard communication protocols. These messages are then parsed and securely routed to the desired end-point applications, interconnecting broker/dealers, investors, and interested third-parties to support a wide range of trade inquiry and real-time trade processing functions.

All major participants in the marketplace are able to access the inventive system. As an example, software and a related application program interface may be provided to brokers/dealers to support all aspects of short-term adjustable rate trading. Buy-side investors, trustees, issuers, and obligors may be provided access to reset calendars, offerings, order entry, position and trade history, and account management. Auction agents may be enabled to manage custodial responsibilities related to auction rate trading.

The main components of the inventive system are the local trading system and its related API, a local message translator, a router, and a centralized hub having its own database for logging and distributing messages. Each end user has its own local and customizable trading system in which the user stores the securities, investors, positions, trades, rate history, etc. that are important to it. Upon desiring a trade or related request/transmission of trade-related data, the end user triggers the sending of a message out via its local API. The message passes through one or more local routers, as well as a message translator to format the message into a standard format, and thence to the centralized hub. The centralized hub stores a copy of the message in a messaging database and also stores user messaging preferences in a user profile database. The user profile database keeps a record of the users' contact, connection, and preference information. The hub determines which other end user or users are supposed to receive the message from the first end user, reformats the now-standardized message into the recipients' preferred formats, and sends the reformatted message along to the intended recipients.

The invention also includes a method of coordinating the trading of securities and instruments with disparate communication modalities. In its most general form, the inventive method includes providing a centralized hub to which a plurality of users are connected by various means. The hub accepts a message of some variety or format from one user and determine the message's validity. The message is analyzed, including the type of data being transmitted and the message's destinations. The format in which the destination users would prefer to receive this message is looked up in a central database. The message is logged into the hub's central database, cloned for each intended destination (if there is more than one). Each cloned copy of the message is then translated to meet the destination user's preferred format and then delivered in the appropriate format for the destination user.

One aspect of the invention is a method of networking various users trading securities. A plurality of instances of trading software residing on one or more computers accessible by a plurality of users are connected to a centralized hub having at least one database. On the database are stored a plurality of user profiles, each of the profiles including at least messaging preferences of the respective users. Trading messages may be sent in a first format from a first sending user to the centralized hub. At the hub, at least one second recipient user of the trading message is determined. The sent message is then transmitted from the hub to at least one second recipient user in accordance with at least one second recipient user's user profile stored on the hub. Additionally, the inventive method preferably includes the steps of validating the first user by the second recipient user, and validating a security, referenced in the message from the first sending user to the second recipient user, by the second recipient user.

Preferably, the format of the sent message is converted from a first format associated with the first sending user to a second format associated with the second recipient user. The converting step may further include the step of normalizing the format of the sent message from the first format to a standard format for handling by the hub. The normalizing step may occur at the first sending user's instance of trading software, or it may occur at the hub. Similarly, the conversion of the message to the second user's format may occur at the second recipient user's instance of trading software, or it may occur at the hub.

The securities handled by the inventive method include short-term adjustable rate securities, such as at least one of auction rate securities, variable rate demand notes, commercial paper, tender option bonds, repurchase agreements, or the like. The various users include at least one of issuers, broker/dealers, investors, potential investors, auction agents, regulators, trustees, or obligors. Part of the sent message may preferably include at least one attribute of a security to be traded, such as at least one of yield, auction date, bidding rights, price tranches, reporting requirements, or investor requirements. Optionally, the identity of at least one of the first sending user or the second recipient user may be concealed from at least the other of the first sending user or the second recipient user, at least until a trade is completed.

Preferably, a copy of the message sent from the first sending user to the second recipient user is stored on the database, and a plurality of the messages are immediately transmitted or, if necessary, queued (with a preferred near-zero lag time) and then transmitted.

Another aspect of the invention is A securities trading system. A plurality of local instances of trading software (either the same or different types of trading software) reside on one or more computers, each of the instances of trading software corresponding to one or more users.

A centralized hub is in communication with the local instances of trading software, the hub including at least one database upon which a plurality of user profiles, each corresponding to one of the users, are stored. The hub is adapted to receive trading messages from at least a first sender of the users and deliver the trading messages to at least a second recipient of the users. Each of the profiles includes at least messaging preferences of their respective users. At least one message translator is in communication with at least one of i) the local instances of trading software, or ii) the hub. At least one message translator is adapted to convert the trading messages from a first format associated with the first sending user to at least one second format.

At least one message translator may include a plurality of message translators respectively residing with the local instances of trading software. Alternatively or in addition, at least one message translator may reside on the hub. In either case, the second format mentioned above may be at least one of a standard format for the hub or a recipient format associated with the second recipient user in accordance with the second recipient user's user profile.

Each of the local instances of trading software further may preferably include a local trading database in which the corresponding user selectively stores information concerning at least one of securities, investors, positions, trades, or rate history, as well as an API. The user sends out the message via its corresponding API to the hub. Alternatively, the user sends out the message via its corresponding API to the message translator and thence to the hub.

Preferably, the hub's at least one database includes a messaging database upon which the messages are stored and a profile database upon which the profiles are stored.

### BRIEF DESCRIPTION OF THE DRAWINGS

FIG. 1 is a schematic of a system in accordance with the invention.

FIGS. 2A-C are a more detailed schematic of portions of the system of FIG. 1.

FIG. 3 is a flow diagram illustrating one embodiment of the movement of a message through a system in accordance with the invention.

FIG. 4 is a schematic depicting one embodiment of the structure of a message in accordance with the invention.

FIG. 5 is a schematic depicting overall flow of a message through a system in accordance with the invention.

### DETAILED DESCRIPTION OF THE INVENTION AND DRAWINGS

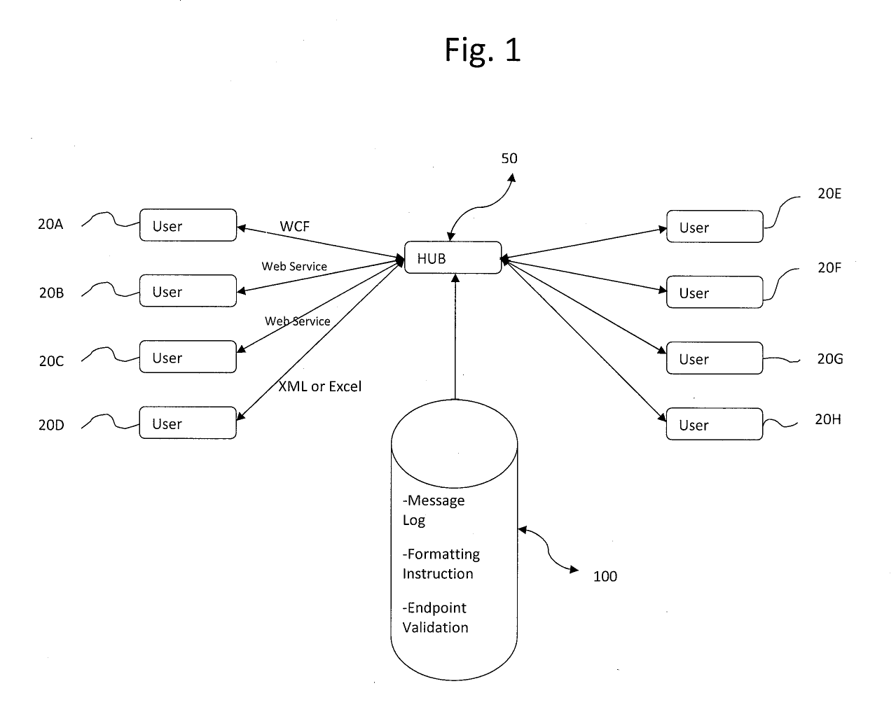

Description of the invention will now be given with reference to FIGS. 1-5. It should be understood that these figures are exemplary in nature and in no way serve to limit the scope of the invention, which is defined by the claims appearing hereinbelow.

As shown broadly in FIG. 1, a plurality of users or clients 20A-H are each connected to central system 10 via a variety of means. For example, user 20A utilizes Windows Communication Foundation (WCF), users 20B and C utilize a web-based service, and user 20D utilizes XML or Excel. Each of users 20A-H represent brokers, or dealers, or investors, or any other participants in the adjustable rate securities trading market or a similar marketplace. Each of these users must be able to communicate with other users in a standardized manner, yet each has its own preferences concerning communications.

As such, each user is connected to hub 50 having database 100. Database 100 records messages that pass from user to user via hub 50. Database 100 also stores each user's formatting instructions in a messaging profile so that, when a message is sent from one user in one format (e.g., user 20A in WCF) to another user who prefers/requires that communications be in another format (e.g., user 20D, who operates in XML), hub 50 is able to convert the message into the appropriate format. Database 100 also records validation from the recipient of the message that the message was properly received.

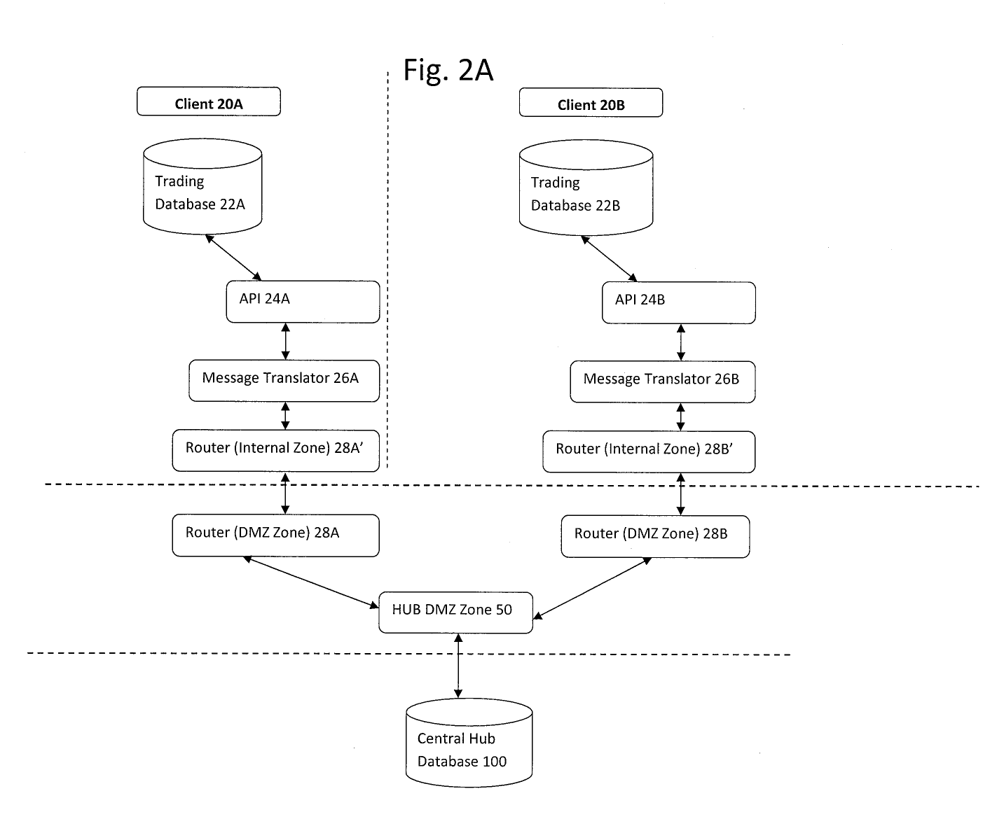

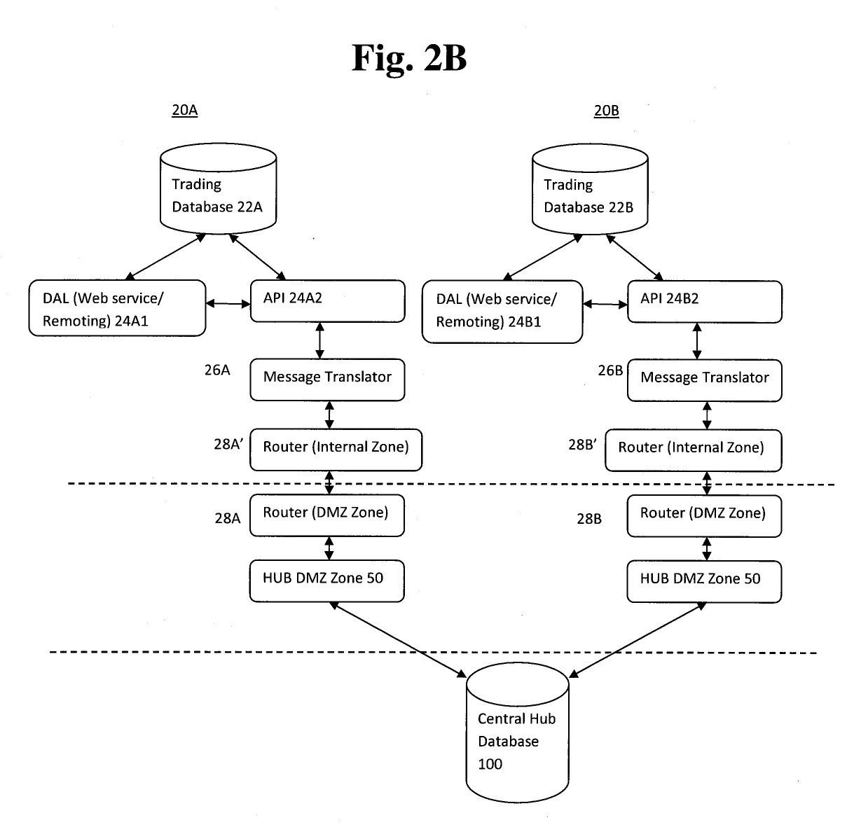

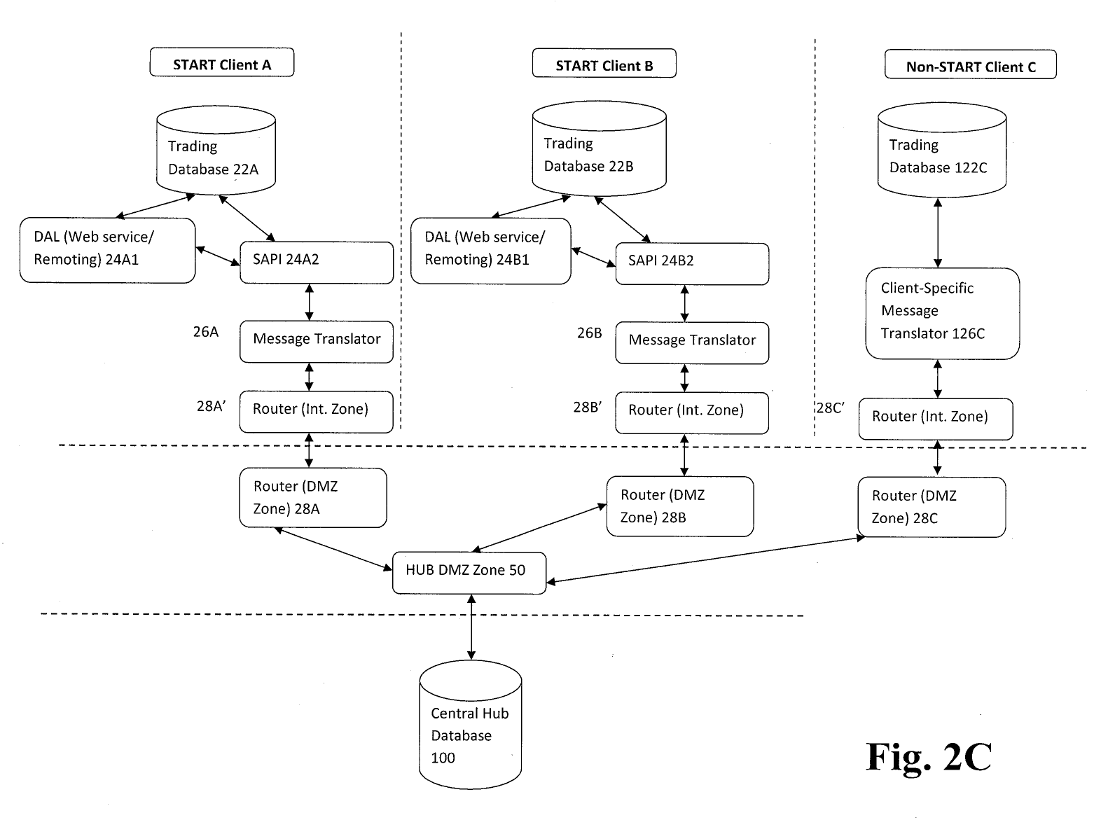

A more detailed view of the user's local software is shown in FIG. 2; FIGS. 2A-C depict three possible configurations of the system (although others are contemplated as well). As shown in FIG. 2A, two users 20A and B are shown; reference will initially be made to a single instance of each element for simplicity. Each user 20 has its own instance of software applications having trading database 22 and its related application program interface (API) 24. In the preferred embodiment, the trading database is the database used by the START software created by Napa Group LLC of New York, the instant assignee, and the preferred API is the START API or SAPI. START (and SAPI) are preferably used by brokers/dealers to support all aspects of Short-Term Adjustable Rate Trading (hence the acronym START). Other software provided by Napa Group adapted to work with the present invention includes STARTex and eGavel. STARTex is preferably used by buy-side investors, trustees, issuers, and obligors, providing reset calendars, offerings, order entry, position and trade history, and account management. eGavel is preferably used by auction agents to manage custodial responsibilities related to auction rate trading. The inventive system is also adapted to work with entities using their own custom code (as described below in connection with FIG. 2C), since the system has great flexibility in translating one client's preferred format into another client's preferred format.

Regardless of the user's choice in software, each user's software also preferably has a message translator 26 which converts an outgoing message from that user into a standardized format suitable for reception at the centralized hub 50, while preserving all of the data of the message. One or more routers 28 are provided for each user to convey the message from a user's internal zone across the user's DMZ and thence on to the DMZ of hub 50.

At hub 50, the destination/recipient user's information is looked up in central hub database 100, which includes the recipient user's preferred format for receiving a message. The message is converted to the preferred format and sent back out from the hub DMZ to the recipient user's DMZ router (in the example of FIG. 2A, router 28B). From there it is forwarded to internal router (28B′) and onto API 24(B).

FIG. 2B is substantially similar to FIG. 2A with one change. In FIG. 2A, API 24A/B is only able to make direct database connections to trading database 22A/B. In FIG. 2B, that which was API 24A/B is now segmented into two components, Data Access Layer (DAL) 24A1/B1 and API 24A2/B2. API 24A2/B2 can now call DAL 24A1/B1 that allows the API to be able to communicate to the Trading Database for added security. DAL 24A1/B1 preferably uses WCF architecture, which enables it to be hosted as a web service or TCP/IP Routing. In embodiments where there are a web server, an application server, and a database server, the web server may not be permitted to make direct calls (for security reasons) to the database server. However, API 24A2/B2 makes the call to the database server via DAL 24A1/B1 which is preferably installed on the application server. The remainder of FIG. 2B is substantially identical to FIG. 2A, and description of like elements will not be repeated.

As mentioned above, the preferred trading database 22 is the one associated with START, and the preferred API 24 is SAPI. However, it is contemplated that not every client will wish to utilize START and SAPI as database 22 and API 24, respectively. As such, the system contemplates accepting messages from non-START users/clients. Exemplary architecture for this feature is shown in FIG. 2C. Here, two clients A and B are using START, and a third client C is not using START but instead a different trading database 122C. Similarly, clients A and B are using SAPI as their API 24, while client C does not have a corresponding local API. Instead, client C can send/receive messages and/or trading data through its own client-specific message translator 126C. Hub 50 will accept the messages/data, send them to clients A and B using client A and B's instances of SAPI, or using an instance of SAPI on hub 50 It is also contemplated that two users/clients communicating with each other will both be using non-START trading software, in which case hub 50 will utilize its own instance of SAPI to facilitate communication therebetween.

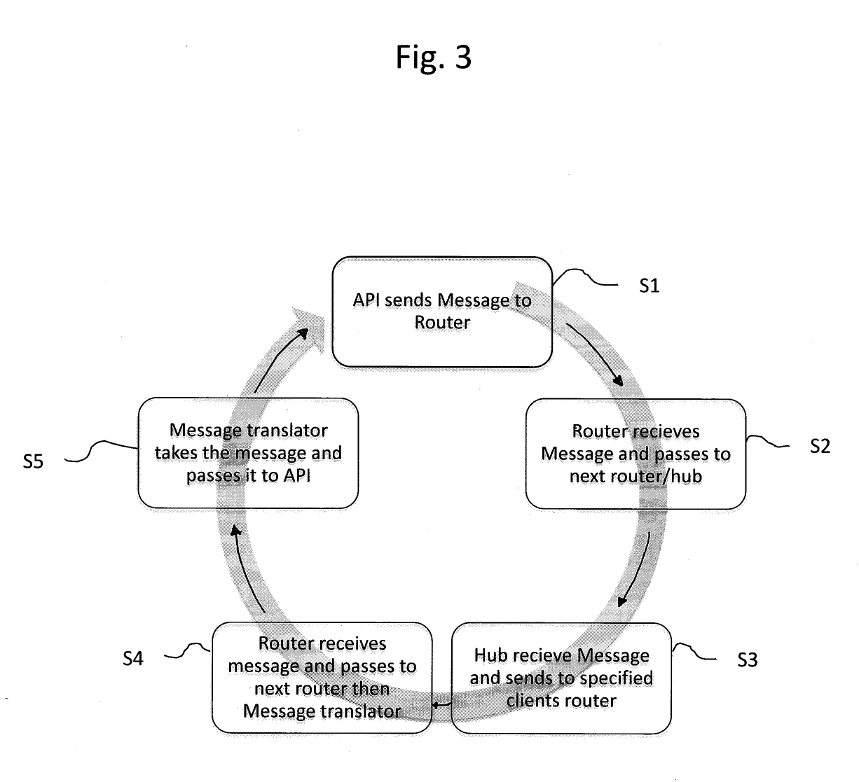

The flow of the message from one user to another is depicted sequentially in FIG. 3. First, a sending user's API sends a message to a router in step S1. The router receives the message and forwards it along in step S2, either to the next router or to the centralized hub. Eventually, the sending user's outermost router sends the message to the hub. At step S3, the hub receives the message, reviews the intended message recipients' address, and looks up the recipient user's preferred/required message format. The hub clones the message for each recipient, reformats the message into the preferred format, and sends the reformatted message to the intended recipients. The hub also logs a copy of the message in the hub database. At step S4, the recipient's outermost router receives the message and passes it along to the next router. Ultimately, the message passes on to the recipient's message translator, which accepts the message; in addition or in the alternative to the hub's reformatting of the message, the recipient's message translator may also interpret or convert the message to a format more suitable for the recipient. Finally, at step S5, the message translator forwards the incoming message to the recipient's instance of the API. The API endpoint is the component that uses the message to accept a trade (assuming the message is concerning a trade) and performs the requisite business logic.

In this process, two types of message validation occur: user level authentication, and security level authentication. For example, if User A wants to buy Security X from User B, User B has to first allow User A to come into the system and then User B has to allow trading (buy and sell) of Security X. Normally, the communication between two clients happens for trading and sharing rate information. When Security X is exposed from User A to User B, and when User A wants to send out notifications of rates, quantities, prices, etc., User B will get those notifications, because Security X is entirely exposed to User B.

Optionally, the identity of one or both of the sending user or the recipient user may be concealed from the other (at least until a trade is completed). The user's trading software may be set up to request that the system mask or conceal the identity of the sender or recipient to the other end user. Alternatively or in addition, anonymity may be a messaging preference appearing in a user profile stored on the hub database.

As mentioned above, the primary protocol used by the system is an optimized message structure capable of carrying any type of data, including full datasets. In a preferred embodiment, these messages are transmitted using Microsoft WCF technology for optimum speed and efficiency. Additional protocols that are supported include FTP file transfer and SMTP email transfer. A sender is able to FTP or email a properly-formatted Excel, XML, or flat text file and have the system interpret it in the same manner as the WCF messages. The same is true for outgoing messages. The configuration database of the hub stores the information that a particular destination prefers to receive message in a particular format (e.g., an Excel document via email), and delivers the message as such.

The system requires policy-based compatibility. A policy is an ordered set of assertions that describe a service's requirements or capabilities. Policies describe semantic requirements or capabilities that cannot be expressed in structural contract languages like XML Schema Definition (XSD) and Web Services Description Language (WSDL). For example, a particular security policy may include assertions that specify the type of token required for client authentication as well as integrity and privacy requirements for each message exchange. The assertions might specify exactly what portions of each message need to be signed and/or encrypted along with what key to use for each task.

The invention utilizes shared schemas and contracts. In the context of the invention, schemas are likened to data, and contracts are essentially behavior concerning that data. The contract contains information regarding the structure of the message. Services do not pass classes and types; they pass schemas and contracts. This allows for a loosely coupled system where it does not matter to the service in which type of environment another service is executing. The information being passed is completely platform-independent.

A message travels from one user's trading system to the designated endpoint and contains the sender and recipient information along with the actual data. An example of data is trade related information (CUSIP, Trade Date, Settlement Date, Coupon, Price, etc.). The message will also contain an array of errors that have occurred en-route. Typically, a message will be generated from the system and passed to the endpoint server (referred below) in the internal network zone of a company's firewall.

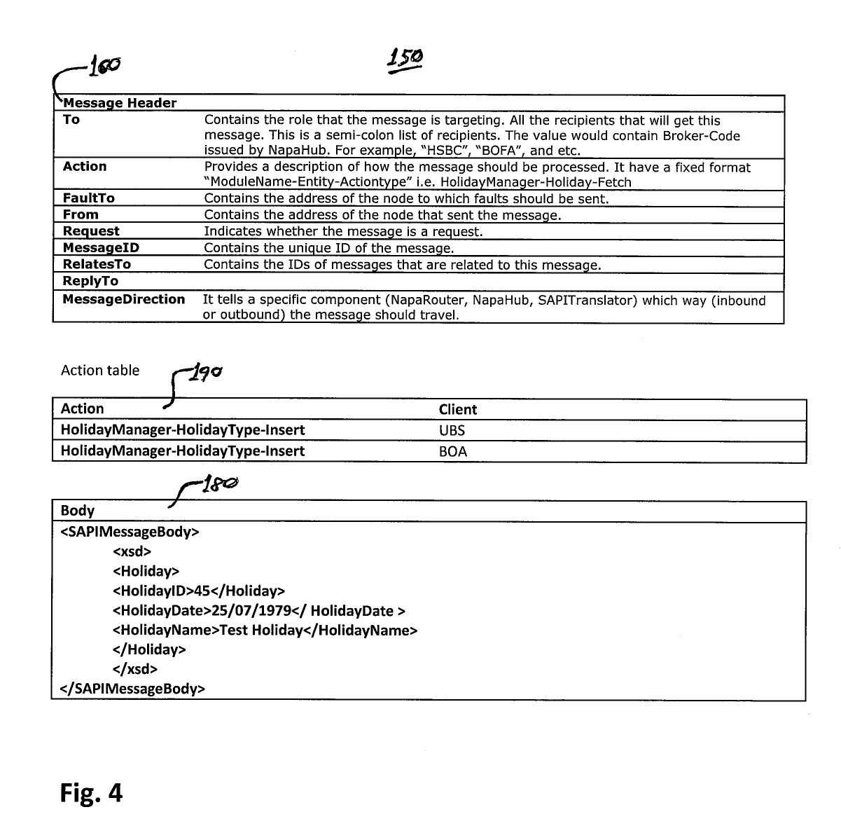

The overall structure of the messages described above is shown in more detail in FIG. 4 and bears some resemblance to an email message. The message 150 contains a message header 160 and message body 180. The message header contains information such as the sender, receiver, message direction, servers a message hops to get to its final destination, and any errors that may occur along way. To make its way to the recipient, an endpoint server is responsible for forwarding a message to the next endpoint server. Each forward adds the forwarding information to the message header. The message is subject to the actions listed in action table 190. Action tables (made up of Entity and ExternalUser tables) give a client the ability to pick and choose what actions they want to be able to perform against another client. For example, if client A wishes to send offering information to clients B and C, they define those rules and mappings in these action tables. As mentioned above, end user identity may be concealed from the sender or the recipient end users if anonymity is desired.

The message body may take the form of variant based message/plain text message, which supports primitive data types; it may contain data contracts. Alternatively, the system may utilize XSD bonded messaging, which supports complex XSD-based types.

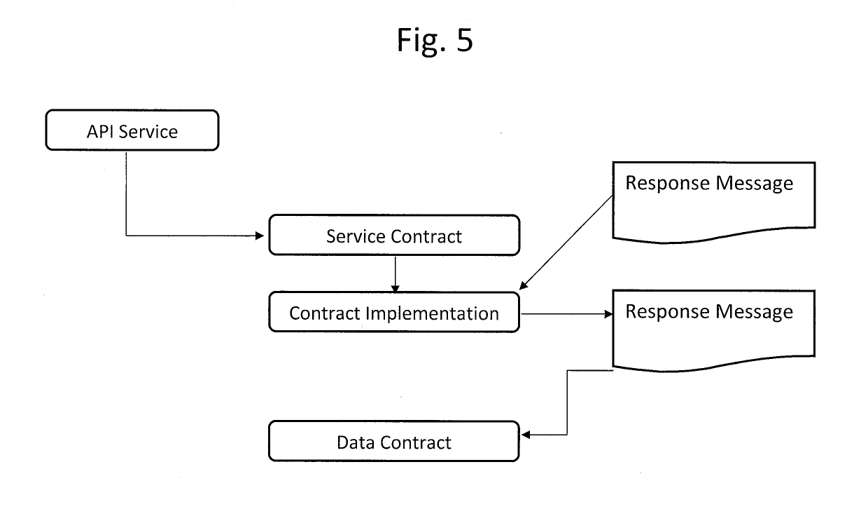

FIG. 5 illustrates an overall view of the flow of data in the system. The flow begins with the API Service (preferably SAPI), which involves the implementation of a contract, for example, submitting a secondary trade. The Service Contract represents the service interface that contains methods blueprint. Contract Implementation comprises methods that can be consumed by a client. In FIG. 5, the messages represent a request or response message that contains data contracts or primitive types (not types from an XSD). The Data Contract represents a serializable type that can be reused across multiple services.

For exception handing and error logging, “Exception Handling Application Block” of MS Enterprise Library is preferably employed.

To manage a transaction in service, the system preferably employs ServiceBehavior Attribute. ServiceBehavior Attribute includes three properties: TransactionAutoCompleteOnSessionClose specifies whether pending transactions are completed when the current session closes; TransactionIsolationLevel determines the isolation level of the transaction; and TransactionTimeout specifies the period in which a transaction has to complete.

OperationBehavior Attribute includes two properties: TransactionAutoComplete specifies that transactions will be auto-completed if no exceptions occur; and TransactionScopeRequired specifies whether the associate method requires a transaction.

Reliable sessions in WCF provide a reliable transfer of messages from one point to another, from the source to its destination. Reliable messaging should be ensured regardless of message transfer failure or other failures, such as transport or network failure.

Each client should have a certificate that can be used for client Secure Socket Layer (SSL) authentication and is trusted by the service. Regarding control of access/authorization, the PrinciplePermission attribute is applied to a WCF service method and is used to restrict access to a service method. When applied to a method, it can be used to demand membership to a specific Windows Group or ASP.NET role.

It is preferred that messages be transmitted immediately. If a message cannot be delivered immediately, the message is preferably queued (with a preferred near-zero lag time) and then transmitted, to ensure guaranteed delivery of messages between clients. Queues provide reliable communication between the sender and receiver of a message, regardless of the environment and parties involved. Direct transport protocols such as TCP or HTTP offer little or no guarantee for a safe and successful message delivery if either the sender or receiver were to quit communicating. In a direct transport scenario, both the sender and receiver must be running to ensure that the application is working correctly. Queued transport provides isolation between the sender and receiver, so that if either the sender or receiver were to stop functioning or the communication between them breaks down, the other party can continue to function, and the delivery of the message is still queued and available for delivery.

The preferred embodiment utilizes Message and Data Contracts. Message and Data Contracts provide a standard way to generate a message that flows over the network using Microsoft's Windows Communication Foundation framework. As mentioned above, the message is composed of a message header and a message body. The message header contains information like the direction the data is flowing (inbound, outbound), recipients, and the like. The message body contains the actual data that needs to be transmitted to another client. Using a Data Contract, one can specify exactly how the service expects the data to be formatted as XML. The Data Contract is used by a Data Contract Serializer in WCF client applications to describe how to serialize the data for parameters into XML, and by a Data Contract Serializer in the service to deserialize the XML back into data values that it can process. Values returned by a service are similarly serialized as XML and transmitted back to the client application, which deserializes them.

In operation, the invention works as follows: As an example (that is not meant to limit the scope of the invention), suppose dealer A wants to show out its offerings in real-time to dealer B. Both dealers are already configured at the hub (a one-time setup) to communicate with the system. Dealer A configures its trading system (e.g., START) to expose a list of securities to dealer B. As trades are executed at dealer A, their offerings go up and down. These changes trigger the API (e.g., SAPI) to send a message to Dealer A's message translator. The message translator pushes the message to one or more routers. The (final) router eventually pushes the message out of dealer A's network to the central hub. The hub interprets the message, determines the destination of the message, and forwards the message to dealer B's router. Dealer B's router (or dealer B's plurality of routers) pushes the message to the dealer B's message translator, which interprets the message and sends it to dealer B's API, which then updates dealer B's trading system. The offering is then available to be displayed on dealer B's instance of the trading system.

The invention is not limited to the above description. For example, as described above, each user's message translator converts an outgoing message into a standardized format for the central hub, and the central hub converts that incoming message into the recipient's preferred/required format. However, the invention also contemplates that the hub forward a standardized message to the recipient user, and the recipient user's message translator converts an incoming standardized message into the recipient user's preferred/required format. In the case of a closed system where both sender and recipient are running the same trading software, then the message translation preferably occurs at the destination's message translator. However, the invention is built to be inclusive, allowing it to preemptively convert a message at the hub if it determines (via its own database information) that the destination does not accept the standardized system message format. For example, if the destination can only receive an XML file via email, then the hub will handle that conversion/translation in advance of sending the message along to the recipient's router. Additionally, the above description focuses, in an exemplary manner, on short-term adjustable rate securities such as auction rate securities. However, it is also contemplated that the invention be equally applicable for trading other securities, including longer term fix income securities, and other financial instruments.

Having described certain embodiments of the invention, it should be understood that the invention is not limited to the above description or the attached exemplary drawings. Rather, the scope of the invention is defined by the claims appearing hereinbelow as well as any equivalents thereof as would be appreciated by one of ordinary skill in the art.

What is claimed is:

1. A method of networking various users trading securities, comprising the steps of:
connecting a plurality of instances of trading software residing on one or more computers accessible by a plurality of users to a centralized hub having at least one database;
storing on the at least one database a plurality of user profiles, each of the profiles including at least messaging preferences of the respective users;
enabling the sending of at least one trading message in a first format from a first sending user to the centralized hub;
determining at the hub at least one second recipient user of the trading message; and
transmitting the sent message from the hub to the at least one second recipient user in accordance with the at least one second recipient user's user profile stored on the hub.

2. A method of networking various users trading securities in accordance with claim 1, further comprising the step of converting a format of the sent message from a first format associated with the first sending user to a second format associated with the second recipient user.

3. A method of networking various users trading securities in accordance with claim 2, wherein said converting step further comprises the step of normalizing the format of the sent message from the first format to a standard format for handling by the hub.

4. A method of networking various users trading securities in accordance with claim 3, wherein said normalizing step occurs at the first sending user's instance of trading software.

5. A method of networking various users trading securities in accordance with claim 3, wherein said normalizing step occurs at the hub.

6. A method of networking various users trading securities in accordance with claim 2, wherein said converting step occurs at the second recipient user's instance of trading software.

7. A method of networking various users trading securities in accordance with claim 2, wherein said converting step occurs at the hub.

8. A method of networking various users trading securities in accordance with claim 1, further comprising the step of concealing the identity of at least one of the first sending user or the second recipient user from at least the other of the first sending user or the second recipient user at least until a trade is completed.

9. A method of networking various users trading securities in accordance with claim 1, wherein the users include at least one of issuers, broker/dealers, investors, potential investors, auction agents, regulators, trustees, or obligors.

10. A method of networking various users trading securities in accordance with claim 1, wherein said sending step further comprises the step of sending as part of the message at least one attribute of a security to be traded.

11. A method of networking various users trading securities in accordance with claim 10, wherein the attribute includes at least one of coupon, yield, reset date, maturity date, bidding rights, offering amount, price or price tranches, reporting requirements, or investor requirements.

12. A method of networking various users trading securities in accordance with claim 1, further comprising the step of storing on the at least one database a copy of the message sent from the first sending user to the second recipient user.

13. A method of networking various users trading securities in accordance with claim 1, further comprising the step of queuing a plurality of the messages during transmission.

14. A method of networking various users trading securities in accordance with claim 1, further comprising the steps of:
validating the first user by the second recipient user; and
validating a security, referenced in the message from the first sending user to the second recipient user, by the second recipient user.

15. A securities trading system, comprising:
a plurality of local instances of trading software resident on one or more computers, each of said instances of trading software corresponding to one or more users;
a centralized hub in communication with said local instances of trading software, said hub including at least one database upon which a plurality of user profiles, each corresponding to one of the users, are stored, said hub adapted to receive trading messages from at least a first sender of the users and deliver said trading messages to at least a second recipient of the users, each of said profiles including at least messaging preferences of the respective users;
at least one message translator in communication with at least one of i) said local instances of trading software, or ii) said hub, said message translator adapted to convert said trading messages from a first format associated with the first sending user to at least one second format.

16. A securities trading system according to claim 15, wherein said instances of trading software comprise different types of trading software.

17. A securities trading system according to claim 15, said at least one message translator further comprising a plurality of message translators respectively residing with said local instances of trading software, wherein said second format comprises at least one of a standard format for said hub or a recipient format associated with the second recipient user in accordance with the second recipient user's user profile.

18. A securities trading system according to claim 15, said at least one message translator resides on said hub, wherein said second format comprises at least one of a standard format for said hub or a recipient format associated with the second recipient user in accordance with the second recipient user's user profile.

19. A securities trading system according to claim 15, each of said local instances of trading software further comprising:
a local trading database in which said corresponding user selectively stores information concerning at least one of securities, investors, positions, trades, or rate history; and
an API,
wherein said user sends out said message via its corresponding said API to said hub.

20. A securities trading system according to claim 17, each of said local instances of trading software further comprising:
a local trading database in which said corresponding user selectively stores information concerning at least one of securities, investors, potential investors, positions, trades, or rate history; and
an API,
wherein said user sends out said message via its corresponding said API to said message translator and thence to said hub.

21. A securities trading system according to claim 18, each of said local instances of trading software further comprising:
a local trading database in which said corresponding user selectively stores information concerning at least one of securities, investors, potential investors, positions, trades, or rate history; and
an API,
wherein said user sends out said message via its corresponding said API to said message translator of said hub.

22. A securities trading system according to claim 15, said at least one database further comprising:
a messaging database upon which said messages are stored;
a profile database upon which said profiles are stored.
